(19) United States
(12) Patent Application Publication
(10) Pub. No.: US 2013/0148031 A1
(43) Pub. Date: Jun. 13, 2013

(54) TELEVISION RECEIVER AND ELECTRONIC DEVICE

(71) Applicants: Yoshinori KOHMOTO, Tokyo (JP); Keiichi MITSUI, Tokyo (JP)

(72) Inventors: Yoshinori KOHMOTO, Tokyo (JP); Keiichi MITSUI, Tokyo (JP)

(73) Assignee: KABUSHIKI KAISHA TOSHIBA, Tokyo (JP)

(21) Appl. No.: 13/611,301

(22) Filed: Sep. 12, 2012

(30) Foreign Application Priority Data
Dec. 9, 2011 (JP) 2011-270687

(51) Int. Cl. H04N 5/44

(52) U.S. Cl. 348/725; 348/E05.096

(57) ABSTRACT

According to one embodiment, television receiver includes: display; flat housing; first member; second member; and electric component. The first member includes an opening through which a screen is exposed and a first wall extending in a thickness direction of the housing between one end of the housing at which the opening is provided and another end of the housing opposite the one end. The first wall covers a circumference of the display. The second member includes a second wall located on the other end and covers the display from an opposite side of the screen. The electric component includes a component surface extending along an internal surface of the second wall on a side of the display away from a center of the internal surface. The component surface is adhered to the internal surface.

### CROSS-REFERENCE TO RELATED APPLICATIONS

This application is based upon and claims the benefit of priority from Japanese Patent Application No. 2011-270687, filed Dec. 9, 2011, the entire contents of which are incorporated herein by reference.

### FIELD

Embodiments described herein relate generally to a television receiver and an electronic device.

### BACKGROUND

Conventionally known is an electronic device having a housing for housing a display device, electric components, and the like.

In such a television receiver or an electronic device, for example, when the thickness, the size, or the weight is reduced, it becomes difficult to ensure the stiffness and the strength of the housing.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view of a television receiver according to a first embodiment;

FIG. 2 is an exemplary side view of the television receiver in the first embodiment;

FIG. 3 is an exemplary schematic diagram illustrating across section taken along the line III-III in FIG. 1, in the first embodiment;

FIG. 4 is an exemplary schematic illustrating a cross section taken along the IV-IV in FIG. 1, in the first embodiment;

FIG. 5 is an exemplary schematic diagram illustrating a cross section of a portion where a first member and a second member of the television receiver are coupled, in the first embodiment;

FIG. 6 is an exemplary perspective view of a protrusion provided to the first member included in the television receiver in the first embodiment;

FIG. 7 is an exemplary perspective view of a protrusion provided to the second member included in the television receiver in the first embodiment;

FIG. 8 is an exemplary perspective view of an electronic device according to a second embodiment;

FIG. 9 is an exemplary schematic diagram of a rear surface of the electronic device in the second embodiment;

FIG. 10 is an exemplary plan view (rear view) of an internal structure of the electronic device including a first member in the second embodiment;

FIG. 11 is an exemplary plan view (front view) of an internal structure of the electronic device including a second member in the second embodiment;

FIG. 12 is an exemplary plan view (front view) of the internal structure of the electronic device including the second member of when a cover is placed on a circuit board, in the second embodiment;

FIG. 13 is an exemplary perspective view of the cover of the circuit board illustrated in FIG. 12, in the second embodiment;

FIG. 14 is an exemplary enlarged plan view (rear view) of a portion of a rear surface of the electronic device in the second embodiment;

FIG. 15 is an exemplary enlarged plan view (rear view) of another portion of the rear surface of the electronic device, which is different from the portion illustrated in FIG. 14, in the second embodiment;

FIG. 16 is an exemplary cross-sectional view taken along the line XVI-XVI illustrated in FIG. 14;

FIG. 17 is an exemplary perspective view of a portion of the first member included in the electronic device in the second embodiment;

FIG. 18 is an exemplary perspective view of a portion of the second member included in the electronic device in the second embodiment;

FIG. 19 is an exemplary perspective view of another portion of the first member of the electronic device, which is different from the portion illustrated in FIG. 17, in the second embodiment;

FIG. 20 is an exemplary perspective view of another portion of the second member of the electronic device, which is different from the portion illustrated in FIG. 18, in the second embodiment;

FIG. 21 is an exemplary perspective view of an internal structure of the electronic device including the first member in the second embodiment;

FIG. 22 is an exemplary perspective view of an internal structure of the electronic device including the second member in the second embodiment;

FIG. 23 is an exemplary perspective view of another portion of the first member of the electronic device, which is different from those illustrated in FIGS. 17 and 18, in the second embodiment; and

FIG. 24 is an exemplary cross-sectional view of an electronic device as viewed from a position equivalent to that of FIG. 3, according to a modification.

### DETAILED DESCRIPTION

In general, according to one embodiment, a television receiver comprises: a display; a flat housing; a first member; a second member; and an electric component. The display comprises a screen. The flat housing is configured to house the display. The first member comprises an opening through which the screen is exposed and a first wall extending in a thickness direction of the housing between one end of the housing in the thickness direction at which the opening is provided and another end of the housing opposite the one end in the thickness direction. The first wall covers a circumference of the display. The first member is configured to support the display, and is a portion of the housing. The second member comprises a second wall located on the other end in the thickness direction and covers the display from an opposite side of the screen. The second member is another portion of the housing. The electric component comprises a component surface extending along an internal surface of the second wall on a side of the display away from a center of the internal surface. The component surface is adhered to the internal surface.

There are some common elements in exemplary embodiments to be described below. Therefore, in explanations below, the same reference numerals are assigned to the same elements, and redundant explanations thereof are partly omitted. In addition, in each of the drawings, directions (an X direction, a Y direction, and a Z direction) are illustrated for convenience. The X direction corresponds to the longitudinal direction of a display screen 4a in a front view. The Y direction corresponds to the short side direction of the display screen 4a in the front view. The Z direction corresponds to the front-back direction of the display screen 4a (depth direction, the thickness direction of the housing 3A) in the front view. The X direction, the Y direction, and the Z direction perpendicularly cross each other.

In the embodiments to be described below, explained as an example is an electronic device configured as a television receiver or a personal computer; however, the electronic device according to the embodiments is not limited thereto. For example, the electronic device according to the embodiment may be various electronic devices such as a smartphone, a smartbook, a cellular phone, a personal digital assistant (PDA), a video display device, and a video phone.

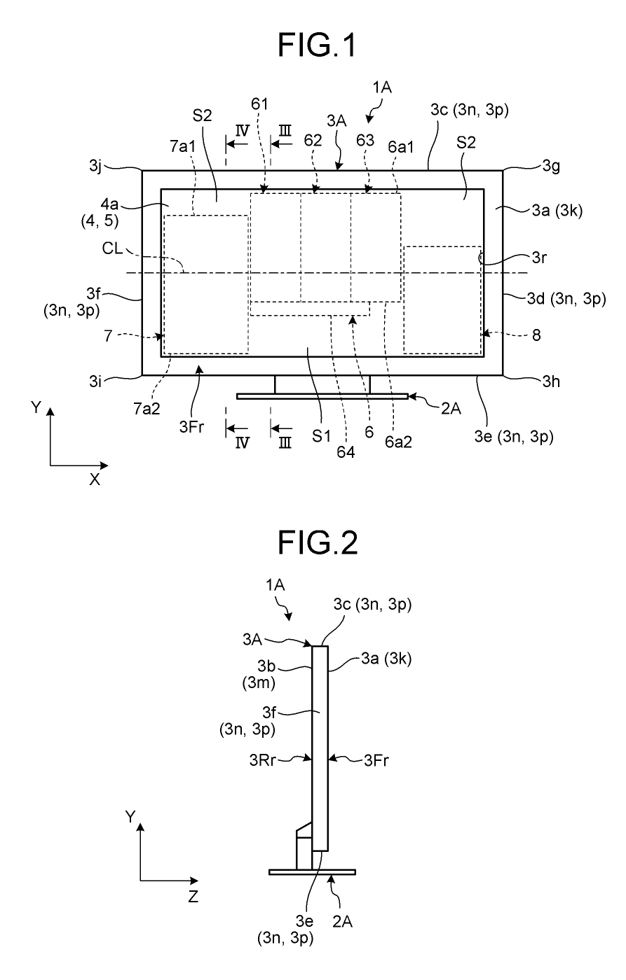

A television receiver 1A that is an example of an electronic device according to a first embodiment comprises a support 2A (a supporting portion, a station, a stand) and the housing 3A, as illustrated in FIGS. 1 and 2. Specifically, the support 2A is placed on a setting area such as a desk, a shelf, and a table (a setting surface not illustrated), and supports the housing 3A at an upright position. To support the housing 3A, the support 2A may be fixed to the housing 3A, or may be movable (rotatable, slidable) with respect to the housing 3A. The support 2A of the housing 3A may be moved (rotated) by being tilted, swiveled, or pivoted, for example.

In the first embodiment, as an example, as may be understood from FIG. 1, the housing 3A has an external appearance of a rectangular shape (in the first embodiment, an oblong shape, as an example) in the front view (and the rear view). The housing 3A is also a cuboid shape that is thin and flat in the front-back direction (the thickness direction of the housing 3A, the Z direction), as illustrated in FIG. 2. The housing 3A comprises a front surface 3a (a frontal surface, a surface, a surface portion) and a rear surface 3b (a back surface, a surface, a surface portion) located opposite the front surface 3a. The front surface 3a and the rear surface 3b are laid approximately in parallel (in the first embodiment, in parallel, as an example). The housing 3A also comprises four ends 3c to 3f (sides, edge portions) and four corners 3g to 3j (pointed portions, curved portions, ends) in the front view, as illustrated in FIG. 1. The ends 3c and 3e are examples of longer sides. The ends 3d and 3f are examples of shorter sides.

The housing 3A comprises a wall 3k (a portion, a plate, a frame, a front wall, a frontal wall, a top wall) including the front surface 3a, and a wall 3m (a portion, a plate, a rear wall, a back wall, a bottom wall, a second wall) including the rear surface 3b. Each of the walls 3k and 3m has a rectangular shape (in the first embodiment, an oblong shape, as an example). The wall 3k also has a frame-like shape, and the wall 3m has a plate-like shape. The housing 3A comprises four walls 3n (parts, plates, side walls, end walls, standing walls, stretched portions, first walls) each of which includes a side surface 3p (a surface, a circumferential surface) and stretches across the wall 3k and the wall 3m. An opening 3r having a rectangular shape is formed on the wall 3k.

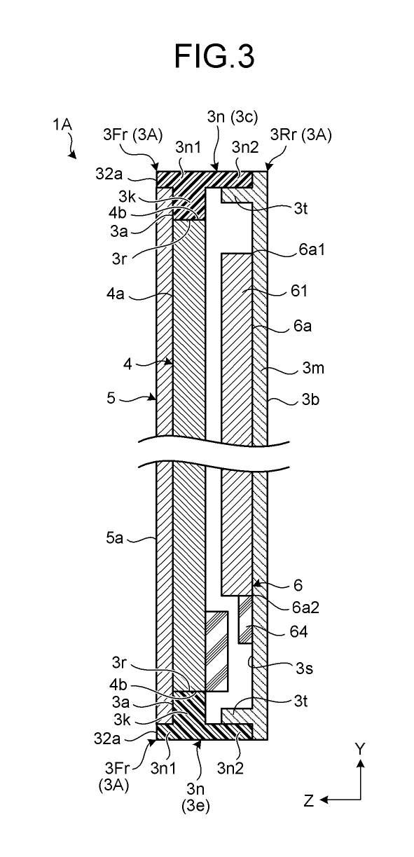

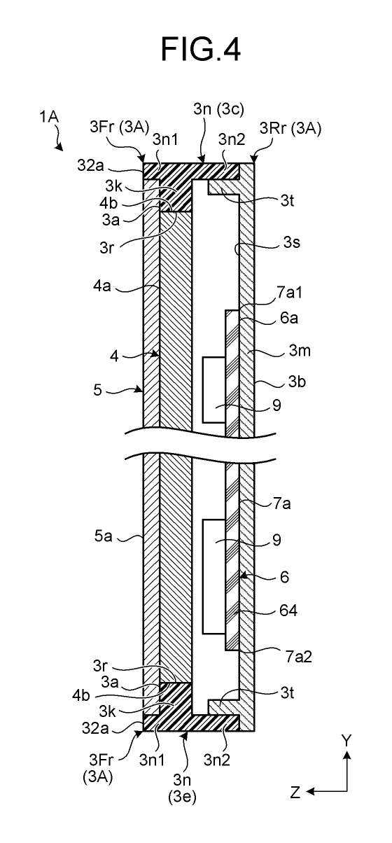

The housing 3A is made up from a combination of a plurality of portions (divided portions, members). The housing 3A comprises a first member 3Fr (a first portion, a front side member, a cover, a bezel, a frame) including at least the wall 3k, and a second member 3Rr (a second portion, a rear side member, a base, a bottom, a plate) at least including the wall 3m, as an example. In the first embodiment, the walls 3n are configured as a portion of the first member 3Fr. Each of the walls 3n stretches across an end 3n1 (one end, a front end, the front surface 3a) located on the side of the opening 3r in the thickness direction of the housing 3A, and an end 3n2 (the other end, a rear end, the rear surface 3b) located opposite the end 3n1 in the thickness direction and covers the circumference (a side surface 4b, see FIGS. 3 and 4) of a display device 4.

In the first embodiment, as an example, the first member 3Fr is made of a synthetic resin material, and the second member 3Rr is made of a metallic material. Because the walls 3n are included in the first member 3Fr, as mentioned earlier, if the first member 3Fr is to be made of a metallic material having a higher specific gravity than that of a synthetic resin material, the housing 3A could become heavy. Furthermore, because the walls 3n are not included in the second member 3Rr, if the second member 3Rr is to be made of a synthetic resin material that is softer (easily bent, deformed) than a metallic material, the stiffness of the housing 3A could be reduced. Because, in the first embodiment, the first member 3Fr is made of a synthetic resin material and the second member 3Rr is made of a metallic material, as an example, the housing 3A can be reduced in weight, while ensuring the stiffness and the strength of the housing 3A. Such a combination of the materials (properties of the materials) is merely an example, and other combinations of materials may also be used.

In the first embodiment, as an example, as illustrated in FIGS. 3 and 4, the display device 4 (a display module, a display, a panel, a display component) is housed in the housing 3A. Specifically, the display screen 4a of the display device 4 located on the side of the front surface 3a is exposed to the front (outside) of the housing 3A through the opening 3r. The display device 4 comprises the display screen 4a and a rear surface 4d that is located opposite the display screen 4a. A user of the display can view the display screen 4a from the front side through the opening 3r. The display device 4 has an external appearance of a rectangular shape (in the first embodiment, an oblong shape, as an example) in the front view. The display device 4 also has a cuboid shape that is thin and flat in the front-back direction. The display device 4 is a liquid crystal display (LCD), an organic electro-luminescent display (OELD), or a plasma display panel (PDP), for example.

In the first embodiment, as an example, as illustrated in FIGS. 3 and 4, a transparent, relatively thin, and rectangular input operation panel 5 (as an example, a touch panel, a touch sensor, an operation surface) is arranged on the front side (frontal side, the side of the wall 3k) of the display device 4. The input operation panel 5 covers the display screen 4a. An operator (e.g., a user) can make inputs by making operations, e.g., touching, pressing, or rubbing the input operation panel 5, or moving a hand, a finger, or a stylus near the input operation panel 5. Light output from the display screen 4a of the display device 4 passes through the input operation panel 5 and travels to the front side (outside) of the housing 3A through the opening 3r on the wall 3k. The input operation panel 5 is an example of an input module.

In the first embodiment, as an example, as illustrated in FIGS. 3 and 4, the first member 3Fr supports the display device 4 and the input operation panel 5. Specifically, the display device 4 and the input operation panel 5 are fixed to the first member 3Fr with fixtures (fixing portions, clamps, e.g., screws, clamps, or portions, not illustrated), an adhesive (e.g., an adhesive agent or a double-sided adhesive tape, not illustrated), and the like. The display device 4 and the input operation panel 5 are fixed to the wall 3k or the walls 3n (the ends 3n1 of the walls 3n). In the first embodiment, as an example, an end 32a (a surface, an end surface) of the first member 3Fr (the wall 3n of the first member 3Fr) that is located on the front side is laid along and continuously to a surface 5a (a front surface, a frontal surface) of the input operation panel 5. In the first embodiment, as an example, the front surface 3a of the wall 3k and the display screen 4a of the display device 4 are also continuous, and are covered by the input operation panel 5.

In the first embodiment, as an example, as illustrated in FIGS. 3 and 4, a battery 6 (a cell, an assembled battery) and boards 7 and 8 (circuit boards, printed boards, control boards; the board 8 is not illustrated in FIGS. 3 and 4) and the like that are electric components are housed in the housing 3A behind the display device 4 (on the side nearer to the rear surface 4d, behind side, back side, the side of the wall 3m, the opposite side of the display screen 4a). The electric components such as the battery 6, the boards 7 and 8, and the display device 4 are electrically connected to each other through a wire (e.g., a cable, a flexible cable, and a flexible printed wiring board) not illustrated.

In the first embodiment, as an example, the battery 6 may be configured as a lithium-ion secondary battery. A lithium-ion secondary battery is a type of a non-aqueous electrolyte battery, and lithium ions in the electrolyte conduct electricity. Manganese, nickel, or iron phosphate is used as a cathode material, and an oxide material such as lithium titanium oxide (LTO) or a carbon material is used as an anode material. Used as electrolyte (electrolyte solution, as an example) is an organic solvent such as ethylene carbonate or diethyl carbonate in which a lithium salt such as florin-based complex salt (LiBF4) is dissolved. In the first embodiment, as an example, the battery 6 is capable of supplying power required for enabling the television receiver 1A to operate, e.g., display videos and output sound, to the boards 7 and 8, and to the electric components in the housing 3A, such as the display device 4 and a speaker (not illustrated) via a connector and wires (neither of which is illustrated). The battery 6 is also capable of supplying power to an external device connected to the boards 7 and 8 via a connector and wires (not illustrated), for example.

In the first embodiment, as an example, as illustrated in FIG. 1, the battery 6 comprises a plurality of cells 61, 62, and 63. The cells 61, 62, and 63 are electrically connected serially or in parallel. The cells 61, 62, and 63 are arranged side by side along the end 3c. In the first embodiment, as an example, the battery 6 comprises a circuit board 64. The electrodes (not illustrated) of the respective cells 61, 62, and 63 are connected (joined) to the circuit board 64 (conductor pattern of the circuit board 64), and, in this manner, the cells 61, 62, and 63 are integrated. Because the cells 61, 62, and 63 are integrated, production labors and costs can be reduced compared with a structure in which the cells 61, 62, and 63 are individually assembled. The circuit board 64 comprises a bus bar (a conductor, not illustrated) that electrically connects the boards 7 and 8 to each of the cells 61, 62, and 63, or between the cells 61, 62, and 63, as an example. Electric components (not illustrated) are arranged (implemented) on the circuit board 64. The electric components and a conductor pattern (wiring pattern not illustrated) on the circuit board 64 together form an electric circuit (an electronic circuit) that realizes a function for monitoring a output power (voltage), temperature, and the like of each of the cells 61, 62, and 63 or the battery 6, as an example.

Each of the cells 61, 62, and 63 is configured as an independent single cell comprising a chamber (an enclosure) in which an electrolyte (an electrolyte solution), electrodes, a separator, and the like are housed (enclosed). Each of the cells 61, 62, and 63 has a cuboid shape (a plate-like shape, a rectangular plate-like shape, a card-like shape) that is thin and flat in the thickness direction of the housing 3A (the Z direction). In the first embodiment, as an example, each of the cells 61, 62, and 63 are covered by an insulating, flexible, sheet-like covering (a skin, a film) that is the outmost layer, without any hard casing (a shell). Therefore, according to the first embodiment, as an example, because the battery 6 has no casing, the battery 6 (the cells 61, 62, and 63) can be reduced in size (thickness) and weight. Therefore, the housing 3A (the television receiver 1A) can be configured small (thin) and light-weighted. In the first embodiment, as an example, each of the cells 61, 62, and 63 is configured as a bag (a portion) partitioned from the others. Therefore, as an example, a local stress applied to the battery 6, because of an external force and the like, can be reduced, compared with a structure in which the cells 61, 62, and 63 are firmly coupled integrally.

In the first embodiment, as an example, a plurality of components 9 (portions, elements, electronic components, electric components) such as a central processing unit (CPU) are implemented on at least one of the boards 7 and 8. The components 9 include heating elements. A cooling mechanism (a heat radiator or a heat receiving element not illustrated) may be provided to the electronic component 9 (a heating element) that generates a large amount of heat. The boards 7 and 8, the components 9, and the like form at least a portion of a controlling circuit (not illustrated). The controlling circuit may include a video signal processing circuit, a tuner, a high-definition multimedia interface (HDMI) signal processor, an audio-video (AV) input terminal, a remote controller signal receiver, a controller, a selector, an on-screen display interface, a storage (e.g., a read-only memory (ROM), a random access memory (RAM), a hard disk drive (HDD)), an audio signal processing circuit, and the like. The controlling circuit controls video outputs (e.g., moving images or still images) from the display screen 4a of the display device 4, sound outputs from a speaker (not illustrated), and light emissions from a light emitting diode (LED) (not illustrated). The display device 4, the speaker, the LED, and the like are examples of an output module.

In the first embodiment, as an example, as illustrated in FIGS. 1, 3, and 4, the battery 6 and the boards 7 and 8 (the board 8 is not illustrated in FIGS. 3 and 4) are not arranged on top of each other in the thickness direction of the housing 3A (in the Z direction), and are instead arranged along an internal surface 3s (first surface) of the wall 3m of the housing. Therefore, the housing 3A can be reduced in thickness compared with a structure in which the battery 6 and the boards 7 and 8 are laid on top of each other in the thickness direction. A surface 6a (a second surface) of the battery 6, a surface 7a (a second surface) of the board 7, and a surface of the board 8 (not illustrated, the surface nearer to the surface 3s, a second surface) adhere (are attached), at least partially, to the surface 3s of the wall 3m with an adhesive agent, a double-sided adhesive tape (an adhesive tape), or the like. Therefore, as an example, fixtures (e.g., screws) and the like for fixing the battery 6 and the boards 7 and 8 to the housing 3A can be reduced, and the housing 3A, and the television receiver 1A in turn, can be reduced in weight. Furthermore, as an example, labors in assembling the battery 6 or the boards 7 and 8 can be reduced. In addition, because the surface 6a of the battery 6 or the surfaces of the boards 7 and 8 adhere to the surface 3s of the wall 3m, the wall 3m can be suppressed from being bent or twisted, as an example. In other words, as an example, the wall 3m can be reinforced by the battery 6 and the boards 7 and 8. Moreover, the heat generated by the battery 6 and the boards 7 and 8 can be released out of the housing 3A more easily via the wall 3m, as an example.

Furthermore, in the first embodiment, as an example, the surface 6a of the battery 6 or the surface of the surface 7a of the boards 7 and 8 adheres to the surface 3s of the wall 3m over both sides of a center (a central line CL; see FIG. 1) of the wall 3m. Preferably, relatively wide area of the surface 6a or 7a adheres to the wall 3m. More preferably, the surface 6a of the battery 6 or the surface 7a of the board 7 adheres to the wall 3m across an area between an end 6a1 located nearer to the end 3c to an end 6a2 located nearer to the end 3e, or across an area between an end 7a1 nearer to the end 3c and an end 7a2 nearer to the end 3e. Therefore, as an example, the wall 3m can be suppressed from being locally bent. Furthermore, in the first embodiment, as an example, the battery 6 is placed nearer to the end 3c (a second end), and the boards 7 and 8 are placed nearer to the end 3e (a first end). Therefore, as an example, a wider area between the end 3c and the end 3e of the wall 3m can be reinforced. Furthermore, as an example, a space S1 between the battery 6 and the end 3e and a space S2 between the boards 7 and 8 and the end 3c can be better utilized for laying other circuit boards or wires. Furthermore, in the first embodiment, as an example, the battery 6 or the board 7 is arranged with some space from the end 3c and the end 3e. Therefore, according to the first embodiment, as an example, the ends 3c and 3e where a hand or a finger can easily touch can be suppressed from being heated by the heat generated by the battery 6 or the boards 7 and 8.

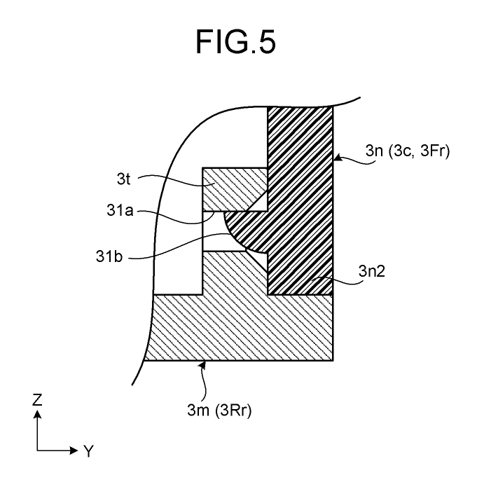

In the first embodiment, as an example, as illustrated in FIG. 5, the second member 3Rr comprises a protrusion 3t (a fourth protrusion) protruding from the wall 3m along the wall 3n of the first member 3Fr on the inner side of the housing. An engaging portion 31a (a first engaging portion) formed on the protrusion 3t and an engaging portion 31b (a second engaging portion) formed on the wall 3n engage with each other in the thickness direction of the housing 3A (in the Z direction). In the first embodiment, as an example, the engaging portions 31a is configured as a through hole, and the engaging portion 31b is configured as a claw (a protrusion, a projection). The first member 3Fr and the second member 3Rr are coupled by the engagement of the engaging portion 31a and the engaging portion 31b. In this manner, in the first embodiment, as an example, the first member 3Fr and the second member 3Rr are coupled using a relatively simple structure.

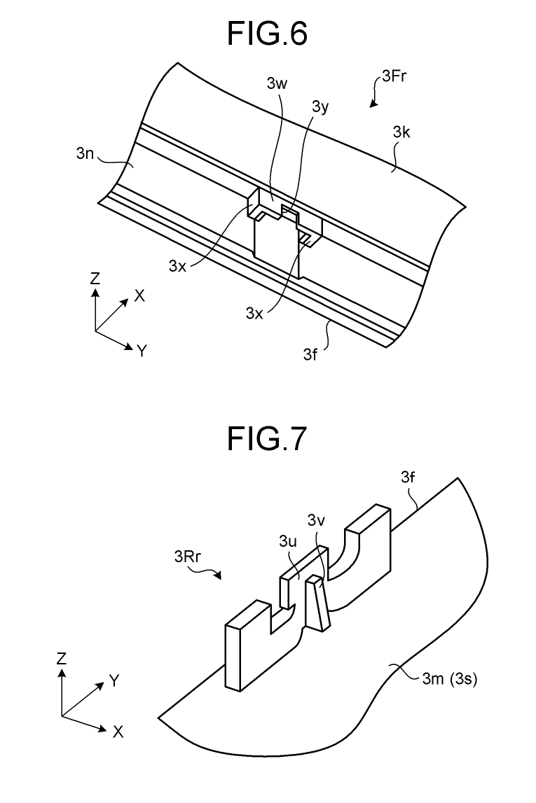

In the first embodiment, as an example, as illustrated in FIG. 7, the second member 3Rr comprises a protrusion 3u (a first protrusion). The protrusion 3u protrudes from the wall 3m along the inner surface of the wall 3n of the first member 3Fr (see FIG. 6) in an assembled housing. A rib 3v (a protrusion) is formed on the internal surface of the protrusion 3u in the housing. As illustrated in FIG. 6, the first member 3Fr comprises a protrusion 3w (a second protrusion, a wall). The protrusion 3w protrudes from the wall 3k toward the wall 3m (along the Z direction) and nips the protrusion 3u (see FIG. 7) with the wall 3n, when the first member 3Fr is assembled to the second member 3Rr. In other words, the protrusion 3w protrudes in a manner so that the protrusion 3u can be received into a space between the protrusion 3w and the wall 3n (e.g., with a space slightly wider than the thickness of the protrusion 3u). The first member 3Fr also comprises two protrusions 3x (third protrusions, walls). These two protrusions 3x engage with the protrusion 3u in a direction along the circumference of the walls 3k and 3m (the direction along the circumference of the display device 4; the Y direction in FIGS. 6 and 7), and protrude from the wall 3k towards the wall 3m. In other words, these two protrusions 3x protrude in a manner so that the protrusion 3u can be received between the protrusions 3x (e.g., with a space slightly wider than the width of the protrusion 3u). In the first embodiment, as an example, when the first member 3Fr and the second member 3Rr are assembled, the protrusion 3u is sandwiched between the walls 3n and the protrusion 3w in the X direction, and is nipped between the two protrusions 3x in the Y direction. As illustrated in FIG. 6, the protrusions 3w and 3x (walls) are connected to each other in a C shape, and are also connected to the wall 3n. In other words, a tubular (rectangular tubular, collar-like) enclosure is formed by the wall 3n and the protrusions 3w and 3x. With this structure, in the first embodiment, as an example, the protrusion 3u provided to the second member 3Rr is suppressed from being moved with respect to the first member 3Fr in a thickness direction of the wall 3n (in the Y direction in the example of FIGS. 6 and 7) or in a longitudinal direction along the wall 3m (in the X direction in the example of FIGS. 6 and 7). Therefore, according to the first embodiment, the edge of the first member 3Fr and the edge of the second member 3Rr held in contact with each other can be suppressed from separating from each other due to an external force and the like, using a relatively simple structure. A cutout 3y (a recessed portion) for receiving the rib 3v when the first member 3Fr and the second member 3Rr are assembled is formed on the protrusion 3w. Therefore, the edge of the cutout 3y formed on the protrusion 3w also functions as a third protrusion, in the same manner as the protrusions 3x.

As explained above, in the first embodiment, as an example, the first member 3Fr comprises the wall 3k and the walls 3n, and the second member 3Rr comprises the wall 3m. Therefore, according to the first embodiment, as an example, because the first member 3Fr integrally comprises the wall 3k and the walls 3n, a highly stiff and strong structure of the housing 3A can be achieved. Furthermore, because the surface 6a of the battery 6 or the surface 7a of the electric components such as the boards 7 and 8 adheres to a given area of the surface 3s of the wall 3m, the wall 3m is further reinforced.

In the first embodiment, as an example, the second member 3Rr comprises the protrusion 3u protruding from the wall 3m along the walls 3n on the inner side of the housing, and the first member 3Fr comprises the protrusion 3w protruding toward the wall 3m and sandwiching the protrusion 3u with the wall 3n. Therefore, according to the first embodiment, as an example, because of the structure in which the protrusion 3u is sandwiched between the wall 3m and the protrusion 3w, the first member 3Fr and the second member 3Rr can be suppressed from being separated by an external force applied in the thickness direction of the walls 3n.

Furthermore, in the first embodiment, as an example, the first member 3Fr comprises the protrusions 3x engaging with the protrusion 3u in a direction along the circumference of the display device 4 and protruding toward the wall 3m. Therefore, according to the first embodiment, as an example, because of this structure in which the protrusion 3u is engaged with the protrusions 3x, the first member 3Fr and the second member 3Rr can be suppressed from being separated by an external force applied in a direction along the circumference of the display device 4.

Furthermore, in the first embodiment, as an example, the second member 3Rr comprises the protrusion 3t protruding from the wall 3m along the wall 3n on the inner side of the housing and having the engaging portions 31a, and the first member 3Fr comprises the engaging portion 31b that is provided to the wall 3n and engages with the engaging portions 31a. Therefore, according to the first embodiment, as an example, the first member 3Fr and the second member 3Rr can be coupled using a relatively simple structure. Furthermore, as an example, a coupling portion that is not visible from outside can be achieved.

An electronic device 1B according to a second embodiment is a personal computer, a television receiver, a smartphone, a smartbook, a cellular phone, a PDA, or the like, such as a so-called slate-type or a tablet type display device having a function of software keyboard.

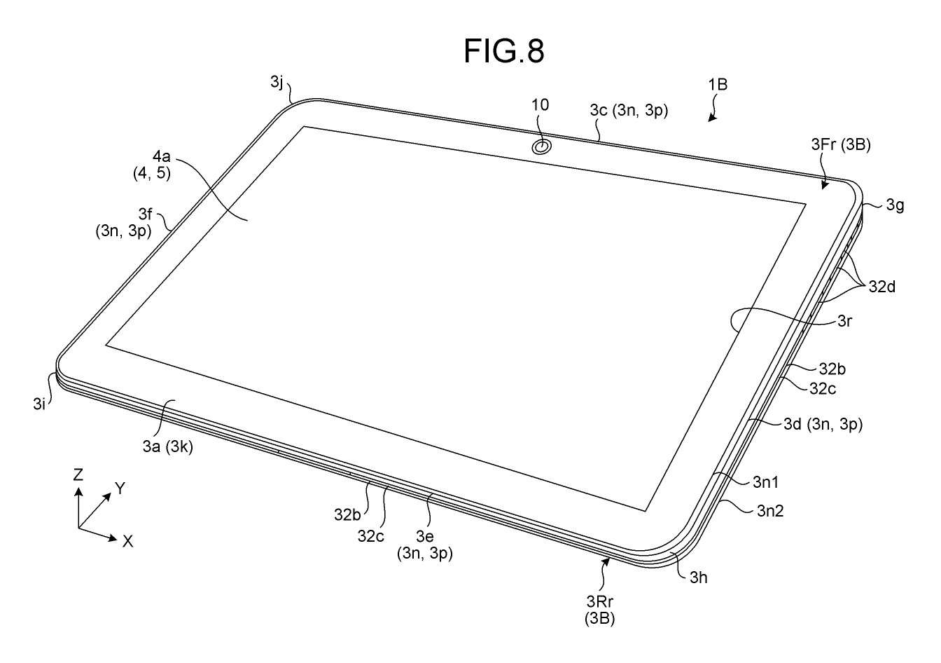

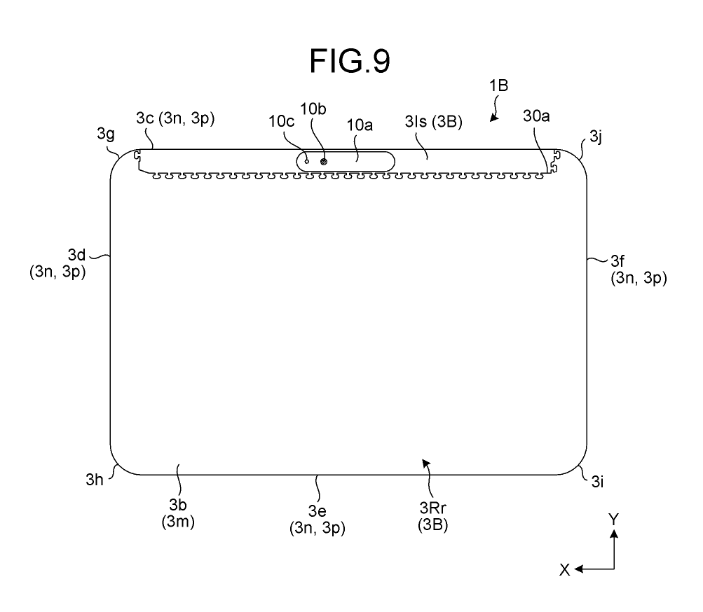

In the second embodiment, as an example, as may be understood from FIGS. 8 and 9, a housing 3B of the electronic device 1B has an external appearance of a rectangular shape (in the second embodiment, an oblong shape, as an example) in the front view and the rear view. The housing 3B is also in a cuboid shape that is thin and flat in the front-back direction (the thickness direction of the housing 3B, the Z direction). The housing 3B comprises a front surface 3a (a frontal surface, a surface, a surface portion) and a rear surface 3b (a back surface, a surface, a surface portion) located on the opposite side of the housing 3B. The front surface 3a and the rear surface 3b are laid approximately in parallel (in the second embodiment, in parallel, as an example). The housing 3B also comprises four ends 3c to 3f (sides, edge portions) and four corners 3g to 3j (pointed portions, curved portions, ends) in the front view. The ends 3c and 3e are examples of longer sides. The ends 3d and 3f are examples of shorter sides.

The housing 3B comprises a wall 3k (a portion, a plate, a frame, a front wall, a frontal wall, a top wall) including the front surface 3a, and a wall 3m (a portion, a plate, a rear wall, a back wall, a bottom wall, a second wall) including the rear surface 3b. Each of the walls 3k and 3m has a rectangular shape (in the second embodiment, an oblong shape, as an example). The housing 3B comprises four walls 3n (portions, plates, side walls, end walls, standing walls, stretched portions, first walls) each of which includes a side surface 3p (a surface, a circumferential surface) and stretches across the wall 3k and the wall 3m. An opening 3r having a rectangular shape, as an example, is formed on the wall 3k.

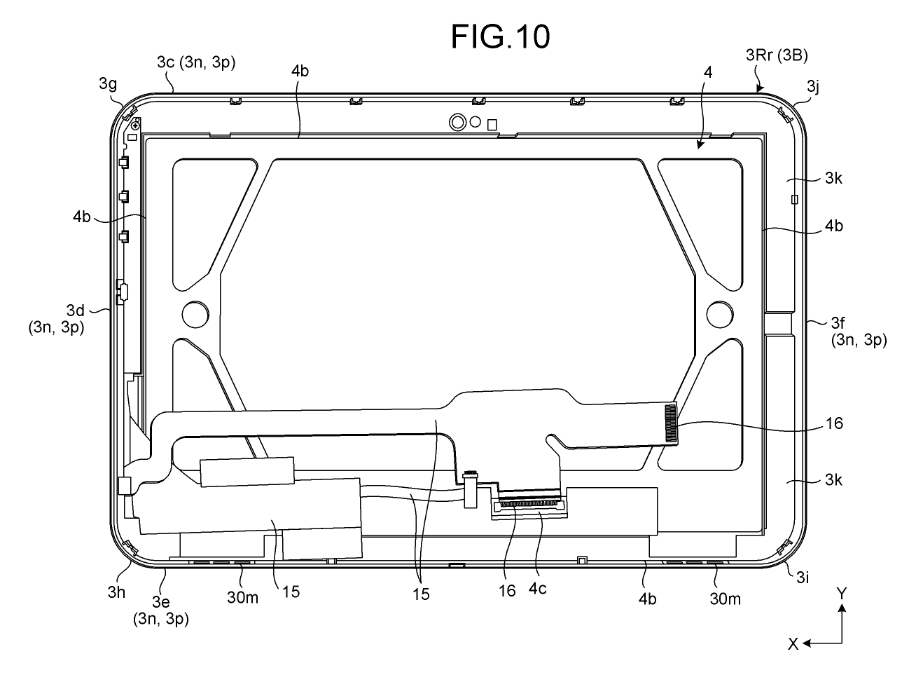

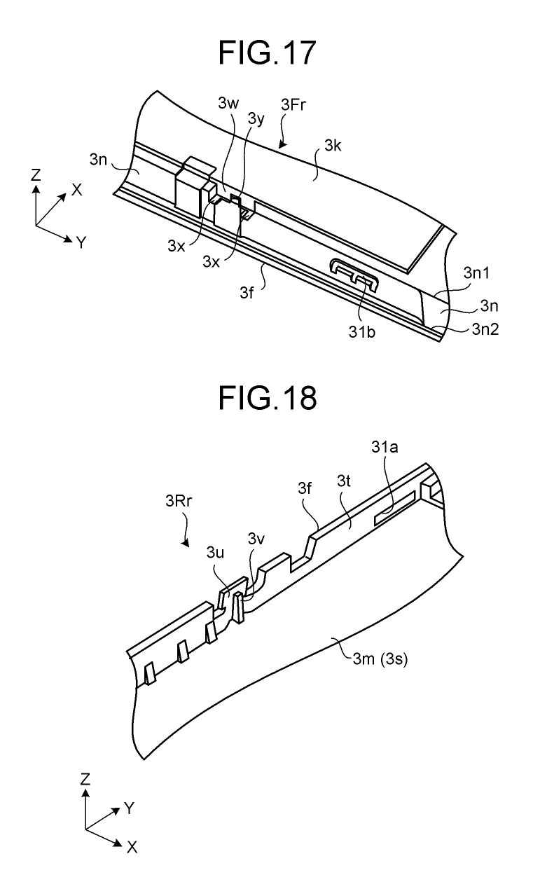

The housing 3B may be made from a combination of a plurality of portions (divided portions). The housing 3B comprises a first member 3Fr (a first portion, a front side member, a cover, a bezel, a frame) including at least the wall 3k, and a second member 3Rr (a second portion, a rear side member, a base, a bottom, a plate) at least including the wall 3m, as an example. In the second embodiment, the walls 3n are basically configured as a portion of the first member 3Fr. In other words, each of the walls 3n stretches across an end 3n1 (one end, a front end, the front surface 3a) located on the side of the opening 3r in the thickness direction of the housing 3B and an end 3n2 (the other end, a rear end, the rear surface 3b) located opposite the end 3n1 (see FIGS. 8, 17), and covers the circumference of the display device 4 (the side surface 4b, see FIG. 10). The walls 3n are thicker than the other walls 3k and 3b. Therefore, the stiffness and the strength in the thickness direction of the housing 3B can be increased easily.

In the second embodiment, as an example, the first member 3Fr is made of a synthetic resin material, and the second member 3Rr is made of a metallic material. Therefore, according to the second embodiment, the weight of the housing 3B can be reduced while ensuring the stiffness and the strength of the housing 3B, in the same manner as in the first embodiment. Such a combination of the materials (properties of the materials) is merely an example, and other combinations of materials may also be used.

As illustrated in FIG. 8, a groove 32b extending along the ends 3c to 3f is formed in the middle (at the center) of the thickness direction of the outer surface of the walls 3n. A member 32c extending along the groove 32b is enclosed (embedded) in at least a portion of the groove 32b. The walls 3n and the member 32c may be made of different materials or have different colors. By configuring the member 32c as a member harder than the walls 3n, as an example, the walls 3n is reinforced. By contrast, by configuring the member 32c as a member that is softer than the walls 3n (as an example, a flexible member), the bendability (flexibility) of the walls 3n is increased, and the member 32c can absorb impacts better, as an example. In a portion of the groove 32b, an operation module 32d such as a switch may be provided, instead of the member 32c. Examples of the switch for the operation module 32d include a power switch, a volume control switch, and a reset switch. The member 32c and the operation module 32d may protrude from the walls 3n by the same height. Such a configuration can make the operation module 32d visually less prominent. Furthermore, because the member 32c and the operation module 32d are provided continuously, aesthetic quality can be improved.

In the second embodiment, as an example, as illustrated in FIGS. 8 and 10, the display device 4 (a display module, a display, a panel, a display component) is housed in the housing 3B. Specifically, the display screen 4a of the display device 4 located nearer to the front surface 3a is exposed to the front (outside) of the housing 3B through the opening 3r. A user of the display can view the display screen 4a from the front side through the opening 3r. The display device 4 has an external appearance of a rectangular shape (in the second embodiment, an oblong shape, as an example) in the front view. The display device 4 also has a cuboid shape that is thin and flat in the front-back direction. The display device 4 is a LCD, an GELD, or a PDP, for example. In the second embodiment, a transparent, relatively thin, and rectangular input operation panel 5 (as an example, a touch panel, a touch sensor, an operation surface) is provided on the front side (frontal side, the side of the wall 3k) of the display device 4, in the same manner as in the first embodiment. Furthermore, in the second embodiment, the first member 3Fr supports the display device 4 and the input operation panel 5, in the same manner as in the first embodiment.

In the second embodiment, as an example, as illustrated in FIGS. 10 to 12, as electric components, the battery 6 (a cell, an assembled battery), the board 7 (a circuit board, a printed board, a control board), a camera module 10 (a camera unit, a camera assembly, an image capturing device), a speaker module 11 (a speaker unit, a speaker assembly, an audio output device), a connector module 12 (a connector unit, a connector assembly, a connector device), an antenna module 13 (an antenna unit, an antenna assembly, an antenna device), an oscillation generating module 14 (a motor having a rotating shaft to which an eccentric weight is attached), and the like are housed in the housing 3B behind the display device 4 (on the side of the rear surface 4b, behind side, back side, the side closer to the wall 3m, on the opposite side of the display screen 4a). These electric components are electrically connected to the other electric components via wires 15 (e.g., a cable, a flexible cable, a flexible printed wiring board).

In the second embodiment, as an example, the battery 6 maybe configured as a lithium-ion secondary battery. In the second embodiment, as an example, the battery 6 is capable of supplying power required for enabling the electronic device 1B to operate, e.g., display videos and output sound, to the display device 4 and electric components installed in the housing 3B via the connector 16 and the wires 15, for example. The battery 6 is also capable of supplying power to an external device connected to the board 7 and the like via the connector 16 and the wires 15, for example.

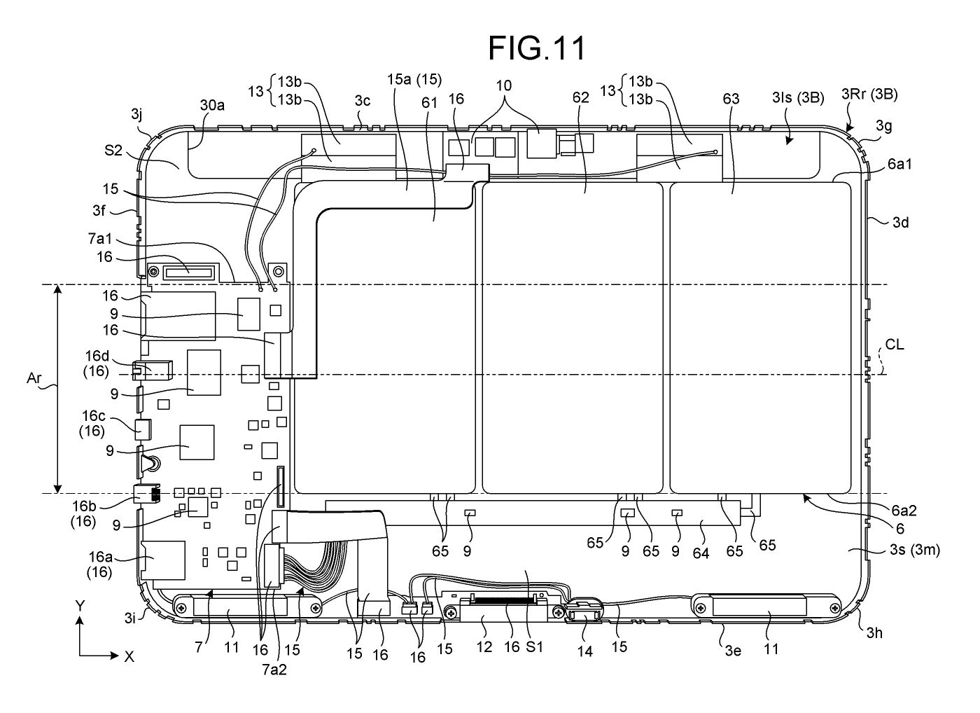

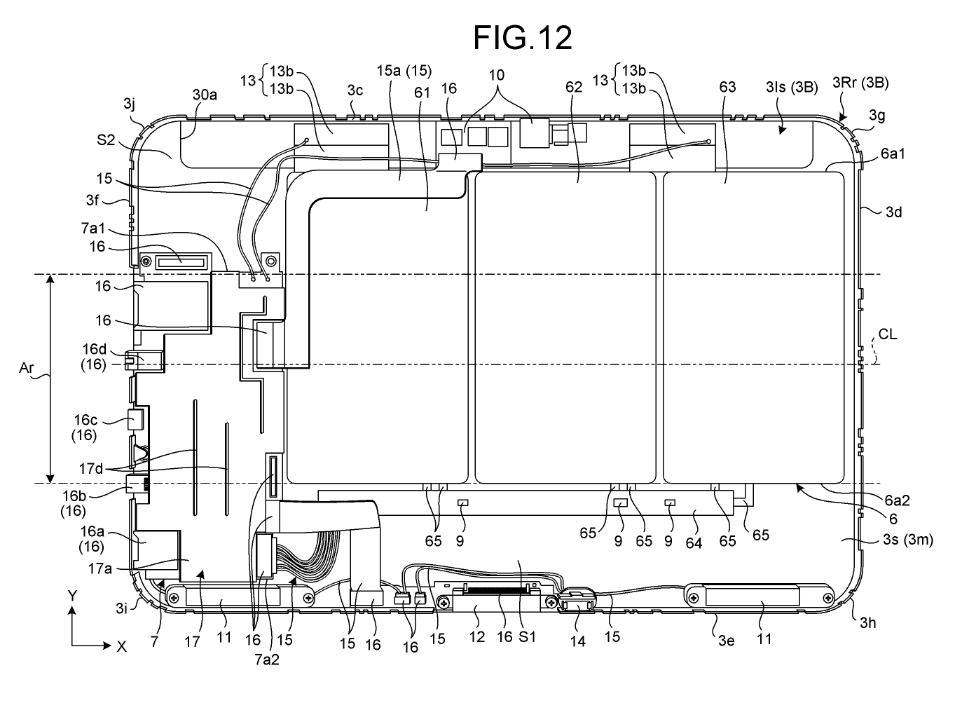

In the second embodiment, as an example, the battery 6 comprise a plurality of cells 61, 62, and 63, as illustrated in FIGS. 11 and 12. The cells 61, 62, and 63 are arranged side by side along the end 3c. In the second embodiment, as an example, the battery 6 comprises a circuit board 64. The electrodes 65 of the respective cells 61, 62, and 63 are connected (joined) to the circuit board 64 (conductor pattern of the circuit board 64), and in this manner, the cells 61, 62, and 63 are integrated. Because the cells 61, 62, and 63 are integrated, production labors and costs can be reduced compared with a structure in which the cells 61, 62, and 63 are individually assembled. The circuit board 64 comprises a bus bar (conductor) that electrically connects the board 7 to each of the cells 61, 62, and 63, or between the cells 61, 62, and 63, as an example. The components 9 are arranged (implemented) on the circuit board 64. The components 9 and the conductor pattern (wiring pattern not illustrated) on the circuit board 64 together form an electric circuit (electronic circuit) that realizes a function of monitoring an output power (voltage), temperature, and the like of each of the cells 61, 62, and 63 or the battery 6, as an example.

Each of the cells 61, 62, and 63 is configured as an independent single cell comprising a chamber (enclosure) in which electrolyte (electrolyte solution), electrodes, a separator, and the like are housed (enclosed). Each of the cells 61, 62, and 63 has a cuboid shape (a plate-like shape, a rectangular plate-like shape, a card-like shape) that is thin and flat in the thickness direction of the housing 3B (the Z direction). In the second embodiment, as an example, each of the cells 61, 62, and 63 are covered by an insulating, flexible, sheet-like covering (skin, film) that is the outmost layer, without any hard casing (shell). Therefore, according to the second embodiment, as an example, because the battery 6 has no casing, the battery 6 (the cells 61, 62, and 63) can be reduced in size (thickness) and weight. Therefore, the housing 3B (electronic device 1B) can be configured small (thin) and light-weighted. In the second embodiment, as an example, each of the cells 61, 62, and 63 is configured as a bag (part) partitioned from the others. Therefore, as an example, a local stress applied to the battery 6 by an external force and the like can be reduced, compared with a structure in which the cells 61, 62, and 63 are firmly integrated.

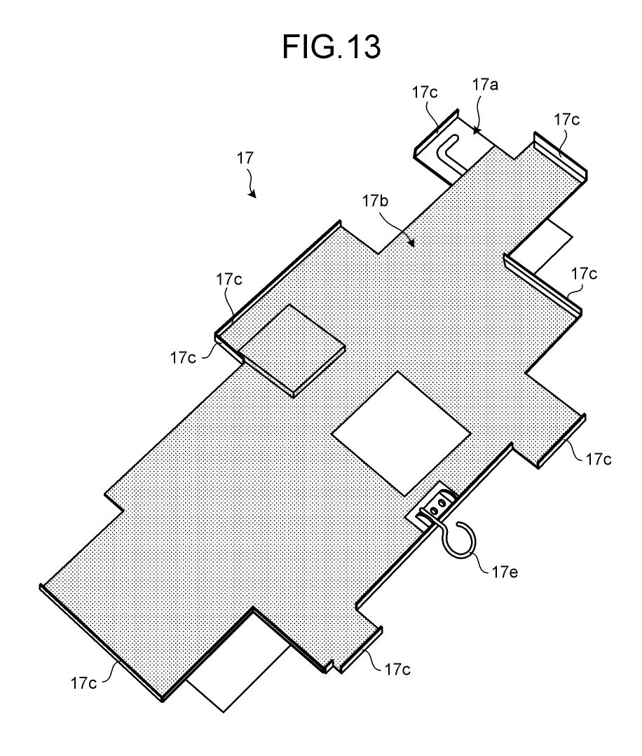

In the second embodiment, as an example, the electronic components 9 such as a CPU, a graphic controller, a power circuit component, a platform controller hub (PCH), a memory slot connector, an LCD connector, an input/output (I/O) connector, a power coil, an element, and a connector can be implemented on the board 7. The electronic components 9 include heating elements. The board 7 (the components 9 on the board 7) may be provided with a cooling device (cooling mechanism). As illustrated in FIGS. 12 and 13, the cooling device 17 comprises a plate-like portion 17a made of a highly heat conductive material (e.g., a metallic material such as an aluminum alloy), and a cooling sheet 17b that adheres, for example, to one surface of the plate-like portion 17a (the surface on the side of the board 7) and having elasticity (flexibility). Engaged portions 17c (claws, folded portions, bent portions, projected portions, projections) that are engaged to the edge of the board 7 are arranged around the edge of the plate-like portion 17a. The engaged portions 17c sandwich the board 7 therebetween elastically, and in this manner, the cooling device 17 is attached to the board 7. The plate-like portion 17a also comprises projecting portions 17d (or recessed portions) each extending in a linear shape, as illustrated in FIG. 12. The projecting portions 17d (or recessed portions) project from the one surface toward the other surface of the plate-like portion, and are recessed from the other surface toward the one surface. Because these projecting portions 17d (or recessed portions) reinforces the plate-like portion 17a, the stiffness and the strength of the plate-like portion 17a is improved. Furthermore, because the engaged portions 17c extend along an edge of the plate-like portion 17a, the stiffness and the strength of the plate-like portion 17a are further improved. A hook 17e (hook portion, hook-like portion) is provided to the plate-like portion 17a. The hook 17e can be hooked onto the board 7, the components 9, or the housing 3Rr. This hook 17e can be used in mounting the cooling device 17.

In the second embodiment, as an example, the board 7 and the components 9 format least a portion of a controlling circuit (not illustrated). The controlling circuit may include a video signal processing circuit, a tuner, an HDMI signal processor, an AV input terminal, a remote controller signal receiver, a controller, a selector, an on-screen display interface, a storage (e.g., a ROM, a RAM, an HDD), an audio signal processing circuit, and the like. The controlling circuit controls video outputs (e.g., moving images or still images) from the display screen 4a of the display device 4, sound outputs from a speaker (not illustrated), and light emissions from an LED (not illustrated). The display device 4, the speaker, the LED, and the like are examples of the output module.

In the second embodiment, as an example, as illustrated in FIGS. 10 to 12, the battery 6 and the board 7 are not arranged on top of each other in the thickness direction of the housing 3B (in the Z direction), and are laid along an internal surface 3s (a first surface) of the wall 3m in the housing. Therefore, the housing 3B can be configured thinner, compared with a structure in which the battery 6 and the board 7 are laid on top of each other in the thickness direction. In the second embodiment as well, the surface (a second surface, not illustrated) of the battery 6 facing the surface 3s of the wall 3m and the surface (a second surface, not illustrated) of the board 7 adhere (are attached), at least partially, to the surface 3s using an adhesive agent, a double-sided adhesive tape, or the like, in the same manner as in the first embodiment. Therefore, in the second embodiment as well, the same advantageous effects as those of the first embodiment, which are achieved because the electric components such as the battery 6 and the board 7 adhere to the wall 3m of the housing 3B, can also be achieved.

In the second embodiment as well, as an example, the surface of the battery 6 and the surface of the board 7 facing surface 3s adhere to the wall 3m over both of the sides of the center (the central line CL; see FIGS. 11 and 12) of the wall 3m. Preferably, relatively wide areas of these surfaces adhere to the wall 3m. More preferably, the surface of the battery 6 and the surface of the board 7 both facing the surface 3s adhere to the wall 3m across the area between the end 6a1 located nearer to the end 3c to the end 6a2 located nearer to the end 3e, and across the area between the end 7a1 nearer to the end 3c and the end 7a2 nearer to the end 3e. Therefore as an example, the wall 3m can be suppressed from being locally bent. Furthermore, in the second embodiment, as an example, the battery 6 is placed nearer to the end 3c (a second end), and the board 7 is placed nearer to the end 3e (a first end). Therefore, as an example, a wider area of the wall 3m between the end 3c and the end 3e can be reinforced. Furthermore, as an example, the area S1 between the battery 6 and the end 3e and the area S2 between the board 7 and the end 3c can be utilized better for laying other circuit boards (e.g., a driver board 4c for the display device 4; see FIG. 10) or the wires 15. Furthermore, in the second embodiment, as an example, the battery 6 and the board 7 are arranged with some space from the end 3c and the end 3e. Therefore, according to the second embodiment, as an example, the ends 3c and 3e where a hand or a finger can easily touch can be suppressed from being heated by the heat generated by the battery 6 or the board 7. Moreover, as may be obvious from FIG. 11, in the second embodiment, as an example, an area Ar where the electric components adhere is laid at the central part of the wall 3m including the central line CL, from one side (the side of the end 3d) to the other side (the side of the end 3f) of a direction along the ends 3c and 3e. Therefore, according to the second embodiment, as an example, the stiffness and the strength of the wall 3m of the second member 3Rr, and the stiffness and the strength of the housing 3B in turn, can be improved.

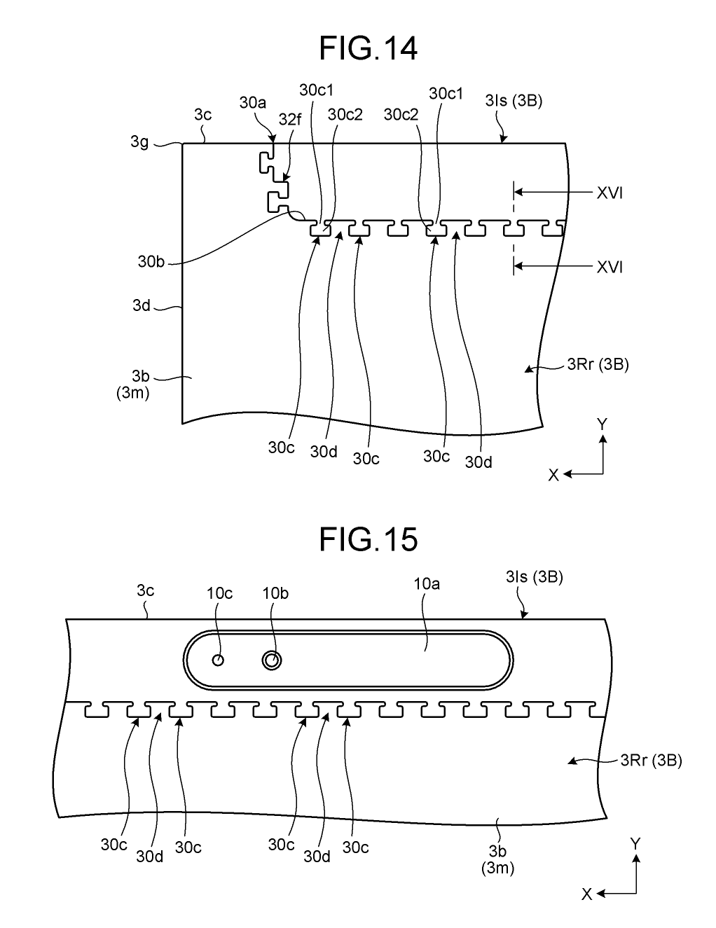

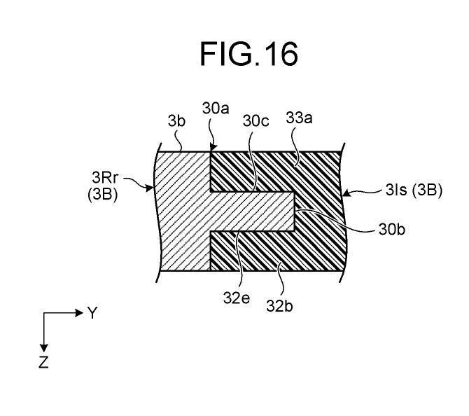

In the second embodiment, as an example, as illustrated in FIGS. 11, 12, 14, and 16, a U-shaped cutout 30a is formed on the end 3c of the second member 3Rr. A third member 3Is made of a low-conductive material (a non-conductive material, an insulating material; e.g., a synthetic resin material) is mounted on the cutout 30a. The third member 3Is is coupled to the cutout 30a on the wall 3m of the second member 3Rr by thermal welding, for example. On an edge 30b of the cutout 30a on the wall 3m, recesses 30c and projections 30d are formed, as illustrated in FIG. 14. Each of the recesses 30c comprises a first portion 30c1 having a narrow width and located on a side of the edge 30b (open side), and a second portion 30c2 having a wider width and located on the inner side. The depth of the recess 30c extends only to the midway of the wall 3m in thickness direction, as illustrated in FIG. 16. Behind the recesses 30c, a stepped portion 32e is formed along the edge 30b of the cutout 30a. The stepped portion 32e extends along the edge 30b, for example. Therefore, in this section, the edge 30b is sandwiched between a first portion 33a filled in the recesses 30c of the third member 3Is and a second portion 33b filled in the stepped portion 32e of the third member 3Is in thickness direction of the wall 3m (the thickness direction of the housing 3B). Each of the projections 30d is provided between the two adjacent recesses 30c. In this manner, the third member 3Is is suppressed from being easily disengaged from the cutout 30a, from three directions of the X direction, the Y direction, and the Z direction, and achieved in this manner is a structure in which the third member 3Is and the second member 3Rr are disengaged from each other less easily even if an external force is applied. Furthermore, a curved portion 32f (a curved portion, a corner, a corner portion, a recessed portion, a projecting portion) that is formed on the edge 30b illustrated in FIG. 14 also suppresses the second member 3Rr and the third member 3Is from easily being disengaged from each other.

In the second embodiment, as an example, as illustrated in FIGS. 11, 12, and 15, the antenna module 13 and the camera module 10 are attached to the third member 3Is made of a low-conductive material. In such a structure, because the conductive material functions as an electromagnetic shield, communications performed via the antenna module 13 can be prevented from being affected. On the side of the rear surface 3b, a cover (a plate) 10a is arranged as illustrated in FIG. 15, and a lens 10b and a light 10c of the camera module 10 are exposed through the cover 10a.

In the second embodiment, as an example, as illustrated in FIGS. 11 and 12, the antenna module 13 comprises a communication module 13a and a grounding module 13b. A part of the grounding module 13b is held between the battery 6 and the wall 3m of the second member 3Rr. By electrically connecting the grounding module 13b to the wall 3m, the electric potential of the wall 3m can be brought closer to the ground level (electric potential) of the grounding module 13b more easily. Therefore, the grounding module 13b can reduce noise introduced to the antenna module 13. In addition, the electric potential of the covering of the battery 6 can be brought closer to the ground level (electric potential) of the grounding module 13b in the antenna module 13 more easily.

In the second embodiment, as an example, as illustrated in FIGS. 11 and 12, wiring 15a (15) electrically connected to the camera module 10 is configured as a flexible printed wiring board, and is laid over the battery 6 in the thickness direction of the housing 3B. Therefore, according to the second embodiment, as an example, the wiring 15a functions as an electromagnetic shield and can suppress communications performed via the antenna module 13 from being affected. Furthermore, in the second embodiment, as an example, as illustrated in FIGS. 11 and 12, the wiring 15a is laid along the edge of the battery 6. Therefore, according to the second embodiment, the wiring 15a can be laid at a position offset from the center of the battery 6 where temperature could be high, as an example.

In the second embodiment as well, as illustrated in FIGS. 17 and 18, the second member 3Rr comprises the protrusion 3t (a fourth protrusion) protruding from the wall 3m along the internal surface of the wall 3n of the first member 3Fr in the assembled housing, in the same manner as in the first embodiment. The engaging portion 31a (first engaging portion) formed on the protrusion 3t and the engaging portion 31b (second engaging portion) formed on the wall 3n engage with each other in the thickness direction of the housing 3B (Z direction). In the second embodiment, as an example, the engaging portions 31a is configured as a through hole, and the engaging portion 31b is configured as a claw (a protrusion, a projection). The first member 3Fr and the second member 3Rr are coupled by the engagement of the engaging portion 31a and the engaging portion 31b. In this manner, in the second embodiment, as an example, the first member 3Fr and the second member 3Rr are coupled using a relatively simple structure.

In the second embodiment as well, as illustrated in FIG. 18, the second member 3Rr comprises the protrusion 3u (a first protrusion) protruding from the wall 3m along the internal surface of the wall 3n of the first member 3Fr in the assembled housing, in the same manner as in the first embodiment. The rib 3v (a protrusion) is also arranged on the internal surface of the protrusion 3u in the housing. In addition, as illustrated in FIG. 17, the first member 3Fr comprises the protrusion 3w (a second protrusion, a wall) protruding from the wall 3k toward the wall 3m (along the Z direction) and sandwiching the protrusion 3u with the wall 3n when the first member 3Fr is assembled with the second member 3Rr. In other words, the protrusion 3w protrudes in a manner so that the protrusion 3u can be received into a space between the protrusion 3w and the wall 3n (e.g., with a space slightly wider than the thickness of the protrusion 3u). The first member 3Fr also comprises the two protrusions 3x (third protrusions, walls) engaging with the protrusion 3u in the direction along the circumference of the walls 3k and 3m (the direction along the circumference of the display device 4; the Y direction in FIGS. 17 and 18), and protruding from the wall 3k towards the wall 3m. In other words, these two protrusions 3x protrude in a manner so that the protrusion 3u can be received between the protrusions 3x (e.g., with a space slightly wider than the width of the protrusion 3u). In the second embodiment, as an example, when the first member 3Fr and the second member 3Rr are assembled, the protrusion 3u is sandwiched between the walls 3n and the protrusion 3w in the X direction, and is sandwiched between the two protrusions 3x in the Y direction. As illustrated in FIG. 17, the protrusions 3w and 3x (walls) are connected to each other in a C shape, and are also connected to the wall 3n. In other words, a tubular (rectangular tubular, collar-like) enclosure is formed by the walls 3n and the protrusions 3w and 3x. With this structure, in the second embodiment, as an example, the protrusion 3u provided to the second member 3Rr is suppressed from being moved with respect to the first member 3Fr in the thickness direction of the wall 3n (in the Y direction in the example of FIGS. 17 and 18) or in the longitudinal direction along the wall 3n (in the X direction in the example of FIGS. 17 and 18). Therefore, according to the second embodiment, as an example, the edge of the first member 3Fr and the edge of the second member 3Rr held in contact with each other can be suppressed from being separated from each other by an external force and the like, in a relatively simple structure. The cutout 3y (a recessed portion) for receiving the rib 3v when the first member 3Fr and the second member 3Rr are assembled is formed on the protrusion 3w. Therefore, the edge of the cutout 3y on the protrusion 3w also functions as the third protrusion, in the same manner as the protrusions 3x.

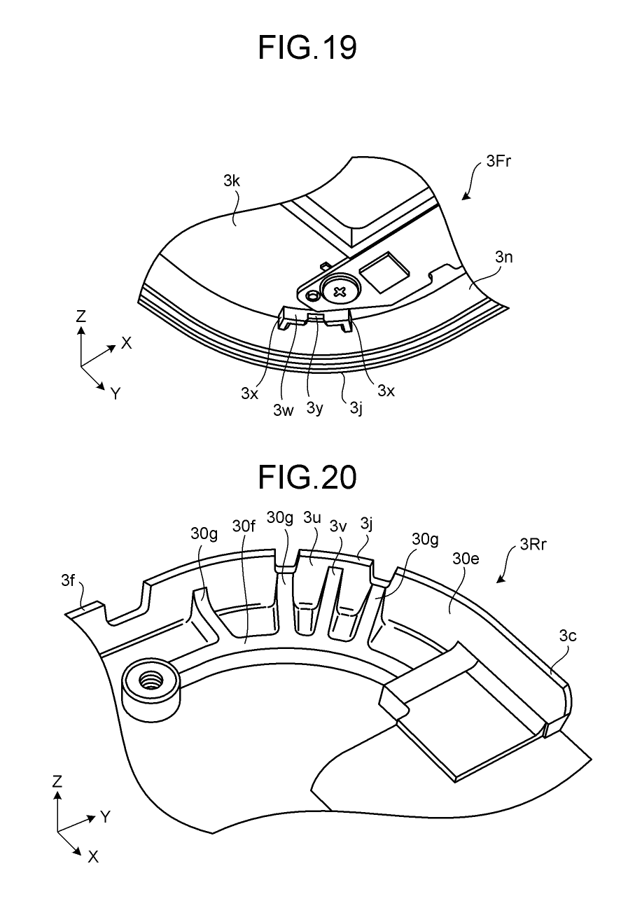

In the second embodiment, as an example, as illustrated in FIGS. 19 and 20, the protrusion 3u (a first protrusion), the rib 3v, the protrusion 3w (a second protrusion), and the protrusions 3x (third protrusions) are also provided to corners 3g to 3j of the housing 3B (only the corner 3j is illustrated in FIGS. 19 and 20). Therefore, according to the second embodiment, as an example, the first member 3Fr and the second member 3Rr are suppressed from separating from each other at the corners of the housing 3B. Furthermore, in the second embodiment, as an example, as illustrated in FIG. 20, the protrusion 3u is connected to a wall 30e curving in an arc-like shape along the edge of the corner 3j of the wall 3m and projecting from the wall 3m toward the wall 3k. Therefore, according to the second embodiment, as an example, the stiffness and the strength of the protrusion 3u can be increased. Furthermore, a protrusion 30f extending in an arc-like shape in parallel with the wall 30e and protruding toward the wall 3k is also provided at a position nearer to the center of the wall 3m than the wall 30e or at a position interspaced from the corner 3j or the ends 3c and 3f. The wall 3m also comprises protrusions 30g (ribs, second ribs) extending between the protrusion 30f (a rib, a first rib) and the wall 30e. The other corners 3g to 3i have the same structure as the corner 3j illustrated in FIGS. 19 and 20. Therefore, according to the second embodiment, as an example, the stiffness and the strength of the protrusion 3u can be increased at the corners 3g to 3j where an external force is most likely to be applied compared with other parts when the electronic device 1B is dropped, for example.

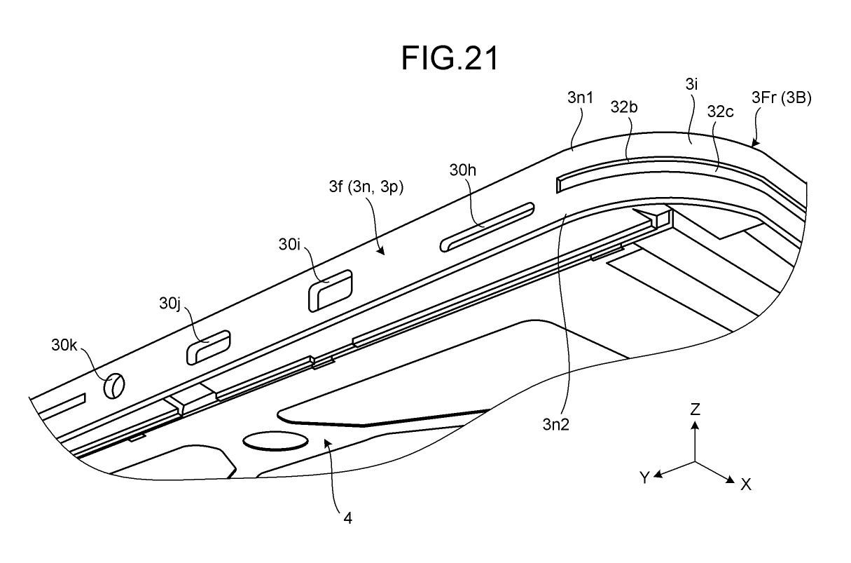

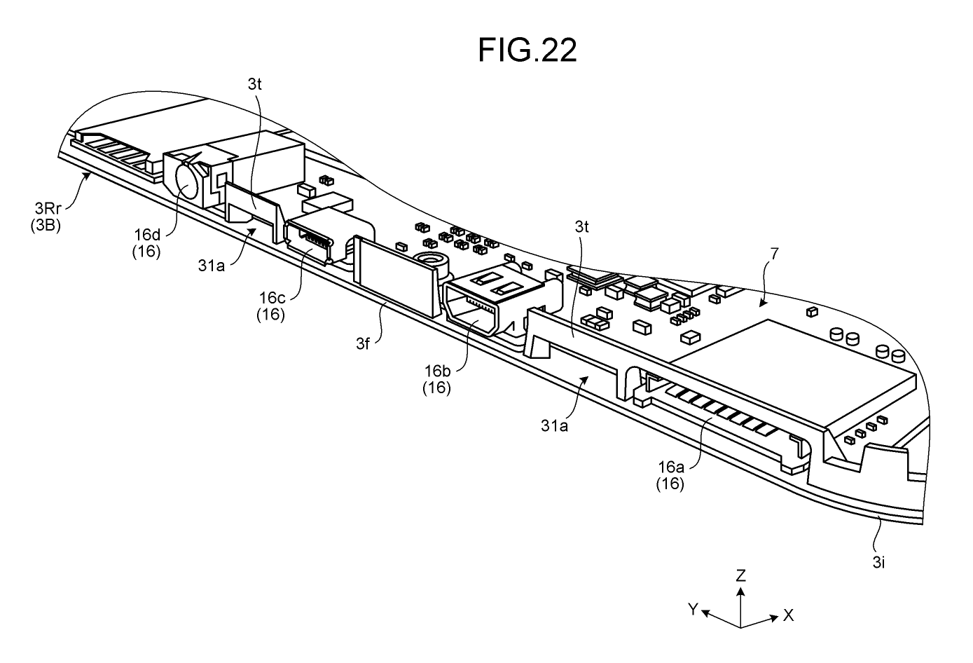

In the second embodiment, as an example, as illustrated in FIG. 21, the wall 3n comprises openings 30h to 30k that are through holes for exposing connectors 16a to 16d arranged side by side along the end 3f illustrated in FIG. 22 to the outside of the housing 3B. Therefore, according to the second embodiment, as an example, the stiffness and the strength of the walls 3n can be improved compared with a structure in which the opening 30h to 30k are provided as cutouts, for example. In FIG. 22, the connector 16a is a connector on which a card is mounted (connected, held) in a removable manner, and the connectors 16b to 16d are connectors on which other connectors are attached (connected, held) in a detachable manner. The terminals (projections, supports, foot portions, protrusions, not illustrated) of the connectors 16b and 16c and the like does not penetrate through the board 7 in the thickness direction, but has a length extending only to a midway in the thickness direction. Therefore, the terminals of the connectors 16b and 16c and the like are suppressed from disturbing the adhesion (attachment) between the board 7 and the wall 3m. By setting the height of the connectors 16b and 16c and the like (the height of the opening) from the board 7 appropriately, the connectors 16b and 16c, and the like and the member 32c arranged at the center of the wall 3n can be arranged side by side (arranged near to each other) in a direction along the ends 3c to 3f (the Y direction in FIG. 21). The protrusions 3t are arranged between the connector 16a and the connector 16b and between the connector 16c and the connector 16d, respectively, and each of the protrusions 3t comprises the engaging portion 31a. The area of the opening of the engaging portion 31a as a through hole is increased toward an opening side (an outlet side, an open-end side). In other words, side surfaces (internal surfaces, inner circumference, internal surfaces of the tube) on the outlet-side end of the engaging portion 31a is further away from the center of the through hole.

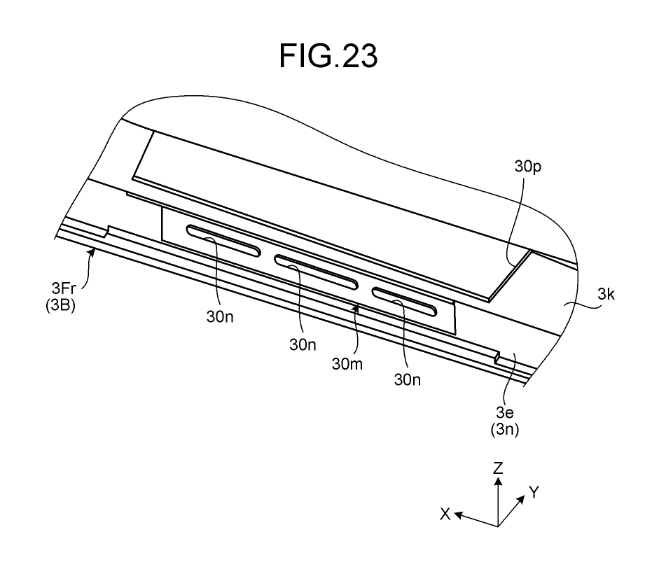

In the second embodiment, as an example, as illustrated in FIG. 23, an member 30m extending along the end 3d is provided to the wall 3n of the first member 3Fr. The member 30m is made of a material harder than that of the first member 3Fr (a metallic material, as an example). Therefore, according to the second embodiment, as an example, the stiffness and the strength of the walls 3n can be increased. The member 30m illustrated in FIG. 23 as an example is arranged facing the speaker module 11, and has openings 30n. These openings 30n enable the sound from the speaker module 11 to be transmitted out of the housing 3B more easily. In other words, the member 30m is an example of a cover of the speaker module 11. A cutout 30p is for holding the speaker module 11 is formed on the wall 3k of the first member 3Fr. Therefore, according to the second embodiment, as an example, the member 30m can reinforce a part that has smaller and strength, because of the cutout 30p, than the other parts with no cutout 30p.

The electronic device 1B according to the second embodiment can also achieve the same advantageous effects achieved by being provided with a similar structure to that of the television receiver 1A according to the first embodiment.

Moreover, the various modules of the systems described herein can be implemented as software applications, hardware and/or software modules, or components on one or more computers, such as servers. While the various modules are illustrated separately, they may share some or all of the same underlying logic or code.

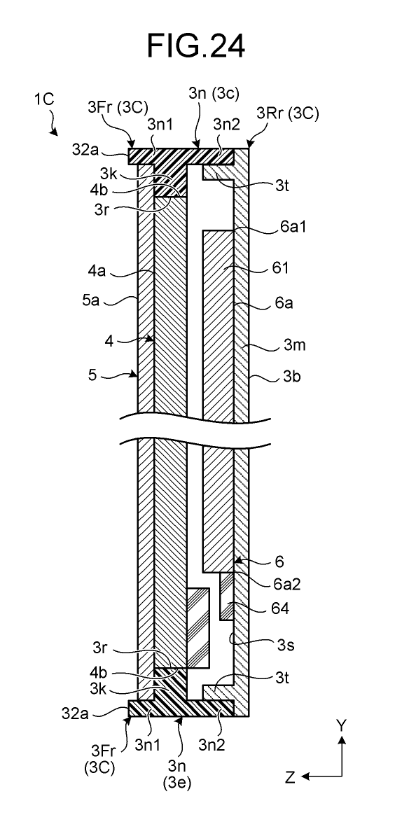

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. For an example, as in an electronic device 1C according to a variation illustrated in FIG. 24, the end 32a of the first member 3Fr included in a housing 3C may be projected further out than the surface 5a of the input operation panel 5. The end 32a thus projected can better protect the input operation panel 5 or the display device 4. Technical characteristics of each of the embodiments may be combined or replaced as appropriate in implementations. Specifications of each element (e.g., a structure, a type, a direction, a shape, a size, a length, a width, a thickness, a height, a number, an arrangement, a position, a material) may also be changed as appropriate in the implementations.

What is claimed is:

1. A television receiver comprising:
a display comprising a screen;
a flat housing configured to house the display;
a first member comprising an opening through which the screen is exposed and a first wall extending in a thickness direction of the housing between one end of the housing in the thickness direction at which the opening is provided and another end of the housing opposite the one end in the thickness direction, the first wall covering a circumference of the display, the first member being configured to support the display and being a portion of the housing;
a second member comprising a second wall located on the other end in the thickness direction and covering the display from an opposite side of the screen, the second member being another portion of the housing; and
an electric component comprising a component surface extending along an internal surface of the second wall on a side of the display away from a center of the internal surface, the component surface being adhered to the internal surface.

2. The television receiver of claim 1, wherein
the second member further comprises a first protrusion configured to protrude from the second wall along the first wall at an inner side of the first wall with respect to the housing of the first wall, and
the first member further comprises a second protrusion configured to protrude toward the second wall while sandwiching the first protrusion with the first wall.

3. The television receiver of claim 2, wherein the first member further comprises a third protrusion configured to engage with the first protrusion in a direction along a circumference of the display and to protrude toward the second wall.

4. The television receiver of claim 2, wherein the first protrusion and the second protrusion are provided at a corner of the housing.

5. The television receiver of claim 1, wherein
the second member comprises a fourth protrusion configured to protrude from the second wall along the first wall on an inner side of the housing and provided with a first engaging portion; and
the first member comprises a second engaging portion provided to the first wall and configured to be engaged with the first engaging portion.

6. The television receiver of claim 1, wherein the first wall comprises a through hole through which a connector provided inside of the housing is exposed.

7. The television receiver of claim 1, comprising a circuit board as the electric component.

8. The television receiver of claim 7, comprising a battery as the electric component.

9. The television receiver of claim 8, wherein
the circuit board is configured to be placed close to a first end of the second wall, and
the battery is configured to be placed close to a second end of second wall located opposite the first end.

10. An electronic device comprising:
a display comprising a screen;
a housing configured to house the display;
a first member comprising an opening through which the screen is exposed and a first wall extending in a thickness direction of the housing between one end of the housing in the thickness direction at which the opening is provided and another end of the housing opposite the one end in the thickness direction, the first wall covering a circumference of the display, the first member being configured to support the display; and
a second member comprising a second wall located on the other end in the thickness direction and covering the display from an opposite side of the screen.

11. The television receiver of claim 10, wherein
the second member further comprises a first protrusion configured to protrude from the second wall along the first wall at an inner side of the first wall with respect to the housing of the first wall, and
the first member further comprises a second protrusion configured to protrude toward the second wall while sandwiching the first protrusion with the first wall.

12. The television receiver of claim 11, wherein the first member further comprises a third protrusion configured to engage with the first protrusion in a direction along a circumference of the display and to protrude toward the second wall.

13. The television receiver of claim 11, wherein the first protrusion and the second protrusion are provided at a corner of the housing.

14. The television receiver of claim 10, wherein
the second member comprises a fourth protrusion configured to protrude from the second wall along the first wall on an inner side of the housing and provided with a first engaging portion; and
the first member comprises a second engaging portion provided to the first wall and configured to be engaged with the first engaging portion.

15. The television receiver of claim 10, wherein the first wall comprises a through hole through which a connector provided inside of the housing is exposed.
